(19) United States
(12) Patent Application Publication
(10) Pub. No.: US 2022/0360427 A1
(43) Pub. Date: Nov. 10, 2022

(54) SYSTEM AND METHOD FOR DIGITAL CIRCUIT EMULATION WITH HOMOMORPHIC ENCRYPTION

(71) Applicant: Duality Technologies, Inc., Maplewood, NJ (US)

(72) Inventor: David Bruce COUSINS, Swansea, MA (US)

(73) Assignee: Duality Technologies, Inc., Maplewood, NJ (US)

(21) Appl. No.: 17/737,480

(22) Filed: May 5, 2022

Related U.S. Application Data
(60) Provisional application No. 63/185,636, filed on May 7, 2021.

(51) Int. Cl. H04L 9/00; G06F 30/32

(52) U.S. Cl. CPC H04L 9/008; G06F 30/32; H04L 2209/12

(57) ABSTRACT

Systems and methods for digital circuit emulation with homomorphic encryption include: receiving, by a hardware design tool chain, a customization file containing a predetermined set of one or more cells; converting, by the hardware design tool chain, a first digital circuit representation in a set of hardware design language (HDL) files into a second digital circuit representation based on the predetermined set of cells in the customization file; receiving, by an encrypted circuit emulator, a set of encrypted inputs; and executing, by the encrypted circuit emulator, the second digital circuit representation using the set of encrypted inputs to generate a set of encrypted outputs.

### CROSS-REFERENCE TO RELATED APPLICATIONS

This application claims the benefit of and priority to U.S. Provisional Patent Application No. 63/185,636, filed May 7, 2021, which is owned by the assignee of the instant application and incorporated herein by reference in its entirety.

### FIELD OF THE INVENTION

The invention relates generally to a system and a method for digital circuit emulation with homomorphic encryption.

### BACKGROUND

Today, massive amounts of data live in many organizations, with barriers between them, erected by mistrust, economic incentives, and regulatory hurdles. When secret data or sensitive data, such as design specifications of certain products and devices, are handled and traded in business, secrecy becomes a major concern for all parties involved because such data may be used to identify or exploit key technologies embedded.

A hardware design language or hardware description language (HDL), as one form of a computer language, is widely used to describe structures and behaviors of an electronic circuit or a digital circuit. HDL may enable detailed descriptions or representation of a digital circuit, which may allow for automated circuit analysis and simulation, such as emulation. HDL may also synthesize the circuit descriptions into a netlist of specifications of physical circuit components and connections to generate a set of masks for manufacturing an integrated circuit.

HDL may be a textual description that may include expressions, statements, and/or control structures, and may include a notion of time. HDL may form an integral part of an electronic design automation (EDA) system, e.g., for application-specific integrated circuits, microprocessors, and/or programmable logic devices.

The digital circuit representation by HDL is often required to be handled for emulation processing as part of circuit analysis and simulation in a secure manner to, for example, prevent third parties from being able to discern and/or reverse engineer the embedded sensitive data and/or valuable technologies, such as algorithms or sequences of instructions, represented by the HDL.

Hence, there is a need for a system and a method for digital circuit emulation such that digital circuit designs and/or specifications, represented by HDL may be safely and securely emulated while, for example, preventing third parties' reverse engineering.

### SUMMARY

Advantages of the invention may include providing digital circuit emulation with homomorphic encryption such that the digital circuit representation by HDL may be safely and securely processed while, for example, preventing third parties' reverse engineering, and also protecting against cybersecurity attackers from understanding the inner-workings of the utilised circuits, thus providing operational security.

According to one or more embodiments, a system for digital circuit emulation with homomorphic encryption, includes: a memory device configured to store: a customization file that contains a predetermined set of one or more cells; and a hardware design tool chain; and a processor configured to: convert a first digital circuit representation in a set of hardware design language (HDL) files into a second digital circuit representation by the hardware design tool chain based on the customization file; and execute, by an encrypted circuit emulator, the second digital circuit representation using a set of encrypted inputs to generate a set of encrypted outputs.

According to some embodiments, the predetermined set of cells in the customization file is a predeveloped set of one or more allowable subcircuits that may be encrypted by homomorphic encryption.

According to some embodiments, the allowable subcircuits includes one or more logic devices.

According to some embodiments, the processor is further configured to save the second digital circuit representation in an interchange format file.

According to some embodiments, converting the first digital circuit representation into the second digital circuit representation includes converting the set of HDL files into an interchange format file of the second digital circuit representation.

According to some embodiments, the set of encrypted inputs further includes plaintext inputs, and the set of encrypted outputs further includes plaintext outputs.

According to some embodiments, executing the second digital circuit representation includes executing encrypted operations of the digital circuit represented in the interchange format file with the set of encrypted inputs.

According to one or more embodiments, a method for digital circuit emulation with homomorphic encryption, includes: receiving, by a hardware design tool chain, a customization file that contains a predetermined set of one or more cells; converting, by the hardware design tool chain, a first digital circuit representation in a set of hardware design language (HDL) files into a second digital circuit representation based on the predetermined set of cells in the customization file; receiving, by an encrypted circuit emulator, a set of encrypted inputs; and executing, by the encrypted circuit emulator, the second digital circuit representation using the set of encrypted inputs to generate a set of encrypted outputs.

According to some embodiments, the predetermined set of cells in the customization file is a predeveloped set of one or more subcircuits that may be encrypted by homomorphic encryption.

According to some embodiments, the subcircuits includes one or more logic devices.

According to some embodiments, a method includes saving the second digital circuit representation in an interchange format file.

According to some embodiments, converting the first digital circuit representation into the second digital circuit representation includes converting the set of HDL files into an interchange format file of the second digital circuit representation.

According to some embodiments, the set of encrypted inputs further includes plaintext inputs, and the set of encrypted outputs further includes plaintext outputs.

According to some embodiments, executing the second digital circuit representation includes executing encrypted operations of the digital circuit represented in the interchange format file with the set of encrypted inputs.

Embodiments of the invention may provide rapid execution of sequential digital circuits as described in a set of HDL input files. Embodiments of the invention may use tool chain technology to convert the input circuit representation described by the HDL files into a new circuit description based on novel special logic devices that are implementable using a Fully Homomorphic Encryption scheme. Embodiments of the invention may read this new circuit description as input and execute the encrypted operation of the circuit using a mix of plaintext and encrypted input sequences, generating a mix of plaintext and encrypted output sequences.

Embodiments of the invention may prevent third parties from being able to discern or reverse engineer the algorithm or sequence of instructions represented by the HDL, even through the use of advanced software reverse engineering tools.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, may be understood by reference to the following detailed description when read with the accompanied drawings. Embodiments are illustrated without limitation in the figures, in which like reference numerals indicate corresponding, analogous, or similar elements, and in which:

FIG. 1 is a block diagram of a computing device, according to some embodiments of the invention;

FIG. 2 is a block diagram of a portion of a system digital circuit emulation with homomorphic encryption, according to some embodiments of the invention;

FIG. 3 is a block diagram of an HDL subcircuit that is encrypted according to some embodiments of the invention;

FIG. 4A is a block diagram of a portion of an HDL circuit that is encrypted, according to some embodiments of the invention;

FIG. 4B is a block diagram of an HDL circuit that is encrypted, according to some embodiments of the invention; and

FIG. 5 is a flowchart for a method for digital circuit emulation with homomorphic encryption, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

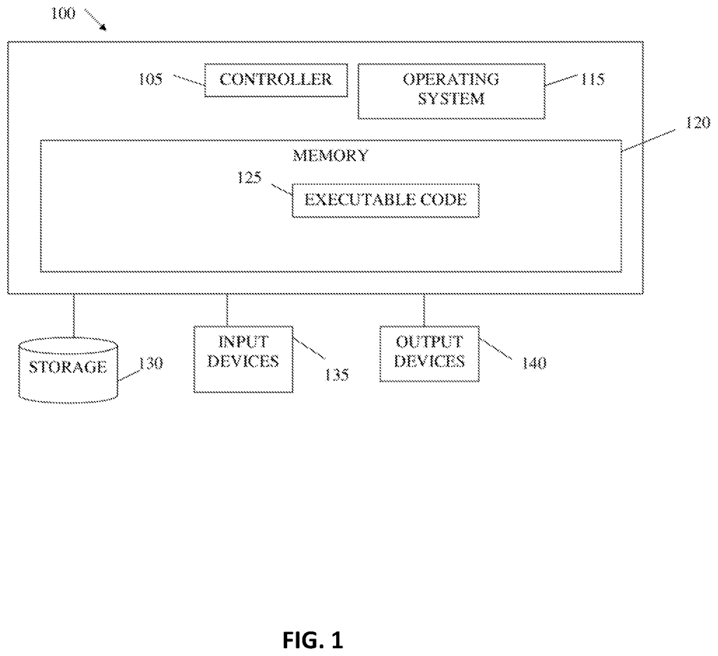

FIG. 1 shows a block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. At least a portion of Memory 120 may include data storage housed online on the cloud. Memory 120 may be or may include a plurality of different memory units. Memory 120 may store for example, instructions (e.g. code 125) to carry out a method as disclosed herein. Memory 120 may use a datastore, such as a database.

Executable code 125 may be any application, program, process, task, or script. Executable code 125 may be executed by controller 105 possibly under control of operating system 115. For example, executable code 125 may be, or may execute, one or more applications performing methods as disclosed herein, such as a machine learning model, or a process providing input to a machine learning model. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105. Storage 130 may include cloud storage. Storage 130 may include storing data in a database.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

In general, a digital representation of a circuit (e.g., a first digital circuit representation) may be used to produce an output (e.g.., a second digital circuit representation) that may allow a circuit emulator to execute an encrypted form of the digital representation of the circuit. The encrypted emulation of the digital representation of the circuit may receive encrypted and/or plaintext input and produce encrypted and/or plain text output produced as part of an emulation of an encrypted version of the input circuit.

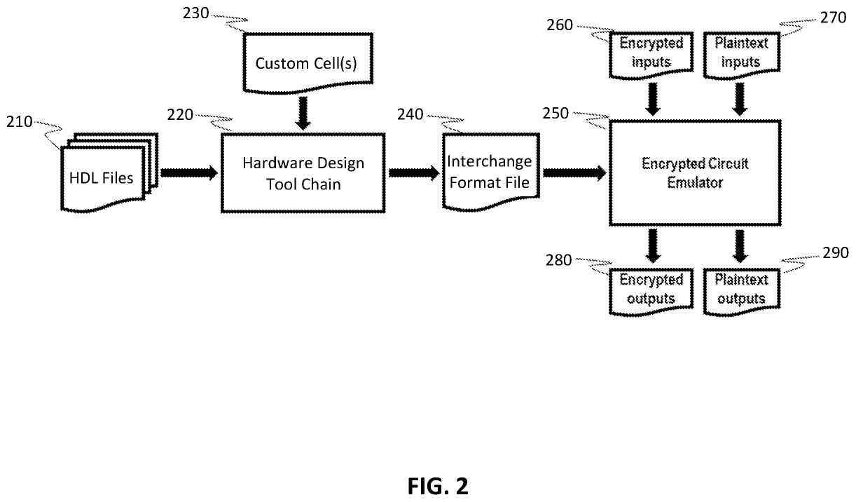

FIG. 2 is a block diagram of a portion of a system 200 for digital circuit emulation with homomorphic encryption, according to some embodiments of the invention. The system 200 may include one or more digital representations of a circuit 210, a hardware design tool chain 220, a customization file 230, an interchange format file 240, an encrypted circuit emulator 250, encrypted inputs 260, plaintext inputs 270, encrypted outputs 280 and plain text outputs 290.

The one or more HDL files 210 may be input to the hardware design tool chain 220.

Each of the one or more digital representations of a circuit 210 may be an HDL file. As is known in the art, each HDL file may contain text-based expressions of the structure of the electronic circuit. Each of the one or more digital representations of a circuit 210 may be representative of any circuit. In some embodiments, the one or more digital representations of a circuit 210 may be any file format commonly used in the art.

The customization file 230 may be input to the hardware design tool chain 220. The customization file 230 may contain one or more custom cells 230. The one or more custom cells 230 may be predetermined based on an encryption scheme to be used. The predetermined set of the one or more custom cells 230 may be input by a user.

The customization file 230 may include an allowable set of changes/customizations to the one or more digital representations of a circuit 210, for example, an allowable set of subcircuits. For example, for a first HDL file, a first customization file may cause encryption of the first HDL file according to one encryption scheme, and a different, e.g. second, customization file may cause encryption of the first HDL file according to another encryption scheme such that the encryption of the same HDL file would be different. The customization file 230 may include a set of one or more standard cells, e.g. group of digital circuit representations of transistors, multiplexor units, latches, switches and/or interconnect structures that may provide a Boolean logic function (such as AND, OR, XOR, XNOR, inverters), or a storage function (such as flipflop or latch). A set of standard cells may differ based on a given encryption protocol, for example, a different encryption protocols may be performed using different standard cells. There may be some equivalency between standard cells for different encryption protocols. The one or more custom cells contained in the customization file 230 may be look up tables.

The hardware design tool chain 220 (e.g. a series of hardware design tool software applications) may convert, e.g. resynthesize, the one or more digital circuit representations 210 into one or more respective second digital circuit representation based on the customization file 230. The converting may be performed by a controller/processor 105 of computing device 100 in FIG. 1.

The converted (e.g., resynthesized) one or more digital circuit representations 210 (e.g. one or more respective second digital circuit representations) may be saved in an interchange format file 240. The interchange format file 240 may be secured by encrypting any programmable variables used in programmable components such as lookup tables, MUXs and switches, so as to protect these elements from being identified. According to some embodiments, converting the one or more digital circuit representations 210 into the one or more respective second digital circuit representation includes converting the set of HDL files 210 into an interchange format file of the second digital circuit representation.

The interchange format file 240 may be an input to an encrypted circuit emulator 250. Encrypted circuit emulator 250 may be a filed programmable gate array (FPGA) circuit compiler. The encrypted circuit emulator 250 may receive encrypted inputs 260 and/or plaintext inputs 270. The outputs may include encrypted outputs 280 and plaintext outputs 290. For example, encrypted circuit emulator 250 may receive a plaintext input 270 and may execute to produce an encrypted output 280. In a decrypting mode, encrypted circuit emulator 250 may receive an encrypted input 260 and may execute to produce a plaintext (e.g. decrypted) output 290.

According to some embodiments, executing the second digital circuit representation includes executing encrypted operations of the digital circuit represented in the interchange format file with the set of encrypted inputs 260.

Encrypted circuit emulator 250 may include an internal set of clocks which may be defined in interchange format file 240 and may execute arbitrary sequential circuits described in the interchange format file 240. Inputs and outputs are clocked into and out of the circuit as specified in the interchange format file 240. Emulator 250 may be implemented in either software or hardware, or as a combination of both.

According to some embodiments, encrypted circuit emulator 250 is embodied as software. Using either the FHEW or TFHE binary encryption scheme with PALISADE open source library, embodiments of the invention include a software system that takes an input file description, generates a netlist of gates (e.g. logic gates) used in the input file, including inputs, clocks, and outputs, and executes encrypted emulations of the gates in an efficient manner, allocating gate emulations to multiple threads as available in the host computer system.

In some embodiments, allowable standard cells in a customization file, such as custom cells 230, are limited to lookup tables, latches, and crossbar switches. In these embodiments, the tool chain technology (e.g. hardware design toolchain 220) may map the output circuit (e.g. as represented in the interchange format file) to a virtual array of lookup tables and crossbar switches in the manner used to program current Field Programmable Gate Array (FPGA) chips. According to some embodiments, circuits encoded in this manner have the quality that the actual look up table implemented may be encrypted, so the actual circuit logic may not be reverse engineered by examining the software flow. Crossbar switches may also be encrypted so the dataflow between circuit elements is also hidden from inspection.

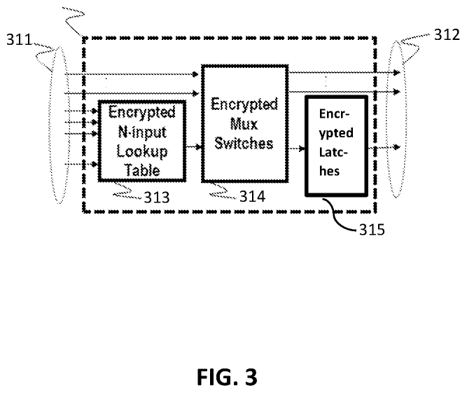

FIG. 3 is a block diagram of an HDL subcircuit 310 that is encrypted according to some embodiments of the invention. The HDL subcircuit 310 may be encrypted. The HDL subcircuit 310 may serve as a basic building block e.g., one of the custom cells of the customization file for an encrypted second circuit representation (e.g. in interchange format file 240), according to some embodiments of the invention. HDL subcircuit 310 may include multiple inputs 311, an encrypted N-input lookup table 313, one or more encrypted MUX switches 314, one or more encrypted latches 315, and multiple outputs 312. HDL subcircuit 310 may correspond to an unencrypted FPGA logic cell, e.g. by not being altered and/or encrypted by the hardware design tool chain 220.

The multiple inputs 311 and outputs 312 to/from the HDL subcircuit 310 may include a mix of encrypted and plaintext Boolean values. The multiple inputs 311 may be input to the encrypted N-input lookup table 313 and the one or more encrypted multiplex switches 314.

The encrypted N-input lookup table 313 may include N inputs, where where N is an integer. The encrypted N-input lookup table 313 may be implemented directly in a modern Boolean based encryption scheme, such as TFHE and FHEW.

The one or more encrypted MUX switches 314 may be coupled to the encrypted N-input lookup table 313. The one or more encrypted MUX switches 314 may receive one or moreof the inputs 311 and receive output from the encrypted N-input lookup table 313. The one or more encrypted MUX switches 314 may be implemented in the same encryption scheme as the encrypted N-input lookup table 313. The one or more encrypted MUX switches 314 may produce any number of outputs.

The one or more encrypted latches 315 may be coupled to the one or more encrypted MUX switches 314. The one or more encrypted latches 315 may produce one output.

In some embodiments, the one or more encrypted latches 315 may be other memory elements. The one or more encrypted latches 315 may be any memory element that may be implemented as a storage of at least one of (but not limited to) a mix of encrypted and plaintext Boolean values.

The internal logic values of the look up table 313 (e.g., the corresponding logic equation for the outputs) may be programmed by the tool chain 220, encrypted as per the scheme used, stored in the interchange format file 240, and remain constant over the execution of the circuit (e.g. emulation by encrypted circuit emulator 250). The settings of the MUXs 314, e.g. the mapping of inputs to outputs, may also be programmed by the tool chain 220, encrypted as per the scheme used, stored in the interchange format file 240 and remain constant over the execution of the circuit.

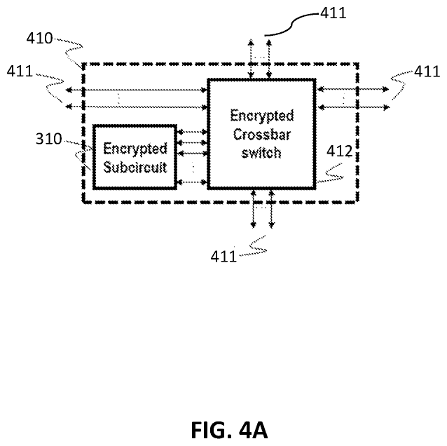

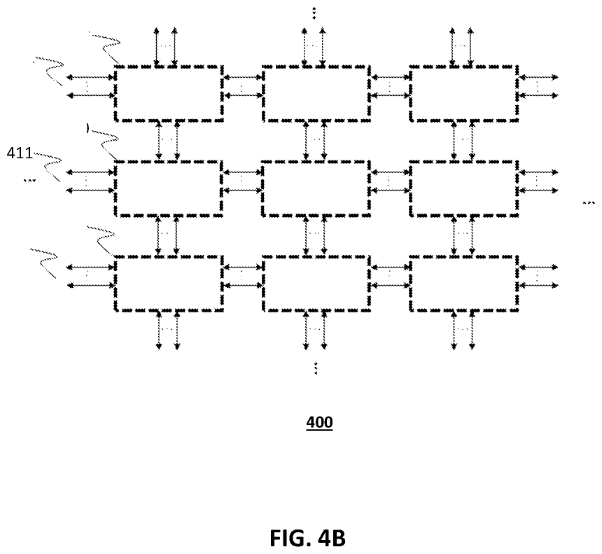

FIG. 4A is a block diagram of a portion of an HDL circuit 410 that is encrypted, according to some embodiments of the invention.

The portion of the HDL circuit 410 has four sets of connections 411. The connections 411 may include be encrypted and/or plaintext Boolean inputs and/or outputs. The four sets of connections 411 may enable connections to other adjacent HDL circuits (not shown in this figure, see e.g., FIG. 4B). In various embodiments, the HDL circuit 410 includes a number of connections 411 different than four, for example fewer than four connections or more than four connections.

The HDL circuit 410 includes subcircuit 310 of FIG. 3 and an encrypted crossbar switch 412. The encrypted crossbar switch 412 may include a series of encrypted MUXs. The series of encrypted MUXs may link any input to any output of 412 once programmed with an encrypted set of switch settings. The settings of the internal encrypted MUXs that compose the encrypted crossbar switch 412, e.g. the mapping of inputs to outputs, may be programmed by the tool chain 220, encrypted as per the scheme used and stored in the interchange format file 240.

FIG. 4B is a block diagram of an HDL circuit 400 that is encrypted, according to some embodiments of the invention. The HDL circuit 400 of a rectangular grid (e.g., array) of portions of HDL circuits (e.g., portion of the HDL circuit 410 as shown above in FIG. 4A) connected by a sets of connections (e.g., set of connections 411 as shown above in FIG. 4A), according to some embodiments of the invention.

The size of the grid may be determined by the tool chain 220, which may map HDL circuits onto a grid of tiles to form a representation of an encrypted HDL circuit. For example, specific connections 411 may be mapped as inputs 260, 270 and outputs 280, 290 by the tool chain 220, as shown above in FIG. 2. This entire grid configuration and the internal programmed settings for each grid component may be captured in the interchange format file 240 and emulated on the Encrypted Circuit Emulator 250. Emulator 250 may clock the circuit multiple times, e.g. evaluate the circuit over several rounds of iteration, as specified by the user. Encrypted Latches 315 of FIG. 3 may allow internal output encrypted logic values from previous clock cycles to be used as inputs for the next clock cycle.

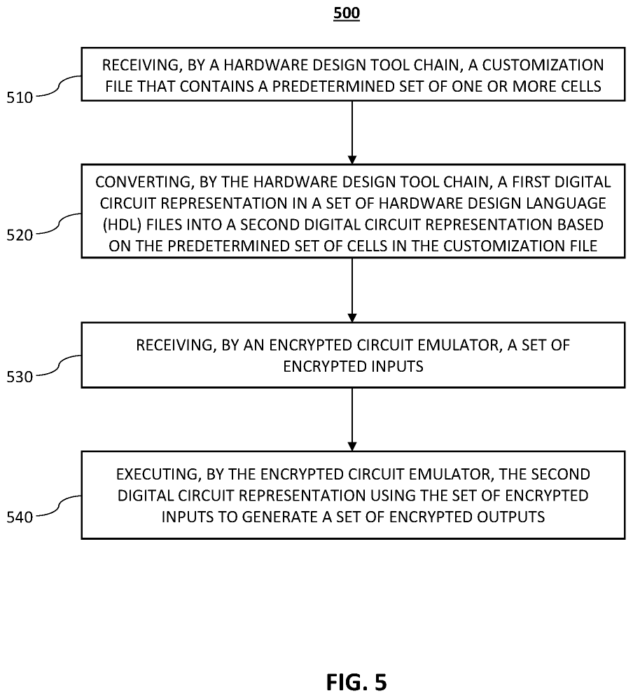

FIG. 5 is a flowchart for a method for digital circuit emulation with homomorphic encryption, according to some embodiments of the invention.

The method 500 may include receiving (510), by a hardware design tool chain (e.g., hardware design tool chain 220 as shown above in FIG. 2), a customization file (e.g., customization file 230 as shown above in FIG. 2) that contains a predetermined set of one or more cells. The predetermined set of one or more cells may be the one or more cells as described above with respect to FIG. 2.

Method 500 may include converting (520), e.g. by the hardware design tool chain, a first digital circuit representation in a set of hardware design language files into a second digital circuit representation based on the predetermined set of cells in the customization file. According to some embodiments, the second digital circuit representation may be saved in an interchange format file. Converting may include transforming, adapting, resynthesizing or otherwise changing the set of HDL files (e.g. the first digital circuit representation) into an interchange format file of the second digital circuit representation. The interchange format file may be interchange format file 240 as described above with respect to FIG. 2.

Method 500 may include receiving (530), by an encrypted circuit emulator (e.g. the encrypted circuit emulator 250 as described above in FIG. 2), a set of encrypted inputs. The inputs may include encrypted inputs and plaintext inputs. The encrypted circuit emulator 250 may also receive the interchange format file 240.

Method 500 may include executing (540), e.g. by the encrypted circuit emulator, the second digital circuit representation using the set of encrypted inputs to generate a set of encrypted outputs. The set of outputs may include encrypted outputs and plaintext outputs. Executing the second digital circuit representation may include executing encrypted operations of the digital circuit represented in the interchange format file with the set of encrypted inputs.

Unless specifically stated otherwise, as apparent from the foregoing discussion, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may include an article such as a computer or processor readable non-transitory storage medium, such as for example a memory, a disk drive, or a USB flash memory encoding, including, or storing instructions, e.g., computer-executable instructions, which when executed by a processor or controller, cause the processor or controller to carry out methods disclosed herein.

It should be recognized that embodiments of the invention may solve one or more of the objectives and/or challenges described in the background, and that embodiments of the invention need not meet every one of the above objectives and/or challenges to come within the scope of the present invention. While certain features of the invention have been particularly illustrated and described herein, many modifications, substitutions, changes, and equivalents may occur to those of ordinary skill in the art. It is, therefore, to be understood that the appended claims are intended to cover all such modifications and changes in form and details as fall within the true spirit of the invention.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures, and examples.

It is to be understood that the details set forth herein do not construe a limitation to an application of the invention.

Furthermore, it is to be understood that the invention may be carried out or practiced in various ways and that the invention may be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps, or integers.

If the specification or claims refer to “an additional” element, that does not preclude there being more than one of the additional elements.

It is to be understood that where the claims or specification refer to “a” or “an” element, such reference is not to be construed that there is only one of that element.

It is to be understood that where the specification states that a component, feature, structure, or characteristic “may”, “might”, “may” or “could” be included, that a particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system for digital circuit emulation with homomorphic encryption, comprising:
a memory device configured to store:
a customization file that contains a predetermined set of one or more cells; and
a hardware design tool chain; and
a processor configured to:
convert a first digital circuit representation in a set of hardware design language (HDL) files into a second digital circuit representation by the hardware design tool chain based on the customization file; and
execute, by an encrypted circuit emulator, the second digital circuit representation using a set of encrypted inputs to generate a set of encrypted outputs.

2. The system of claim 1, wherein the predetermined set of cells in the customization file is a predeveloped set of one or more allowable subcircuits that may be encrypted by homomorphic encryption.

3. The system of claim 1, wherein the allowable subcircuits includes one or more logic devices.

4. The system of claim 1, wherein the processor is further configured to save the second digital circuit representation in an interchange format file.

5. The system of claim 1, wherein converting the first digital circuit representation into the second digital circuit representation includes converting the set of HDL files into an interchange format file of the second digital circuit representation.

6. The system of claim 1, wherein the set of encrypted inputs further includes plaintext inputs, and the set of encrypted outputs further includes plaintext outputs.

7. The system of claim 1, wherein executing the second digital circuit representation includes executing encrypted operations of the digital circuit represented in the interchange format file with the set of encrypted inputs.

8. A method for digital circuit emulation with homomorphic encryption, comprising:
receiving, by a hardware design tool chain, a customization file that contains a predetermined set of one or more cells;
converting, by the hardware design tool chain, a first digital circuit representation in a set of hardware design language (HDL) files into a second digital circuit representation based on the predetermined set of cells in the customization file;
receiving, by an encrypted circuit emulator, a set of encrypted inputs; and
executing, by the encrypted circuit emulator, the second digital circuit representation using the set of encrypted inputs to generate a set of encrypted outputs.

9. The method of claim 8, wherein the predetermined set of cells in the customization file is a predeveloped set of one or more subcircuits that may be encrypted by homomorphic encryption.

10. The system of claim 9, wherein the subcircuits includes one or more logic devices.

11. The method of claim 8, further comprising saving the second digital circuit representation in an interchange format file.

12. The method of claim 8, wherein converting the first digital circuit representation into the second digital circuit representation includes converting the set of HDL files into an interchange format file of the second digital circuit representation.

13. The method of claim 8, wherein the set of encrypted inputs further includes plaintext inputs, and the set of encrypted outputs further includes plaintext outputs.

14. The method of claim 8, wherein executing the second digital circuit representation includes executing encrypted operations of the digital circuit represented in the interchange format file with the set of encrypted inputs.
